(19) United States
(12) Patent Application Publication
(10) Pub. No.: US 2017/0369002 A1
(43) Pub. Date: Dec. 28, 2017

(54) Truck Floor System

(71) Applicant: Frank Anthoney Miles, Newnan, GA (US)

(72) Inventor: Frank Anthony Miles, Newnan, GA (US)

(21) Appl. No.: 15/190,084

(22) Filed: Jun. 22, 2016

(51) Int. Cl. B60R 13/01; B62D 33/02

(52) U.S. Cl. CPC B60R 13/01; B62D 33/02; B60R 2013/015; B60R 2013/018

(57) ABSTRACT

A truck floor system typically used in aftermarket applications such as restoring vintage truck beds is disclosed. The floor system uses non-wooden boards containing either custom graphics or printed images of wood grain patterns. Images may be printed on adhesive backed media and applied to the board or printed directly on the board itself. A protecting layer of clear abrasion resistant material or a sprayed on coating is applied to minimize damage and protect against weather.

### CROSS REFERENCE TO RELATED APPLICATIONS:

This application claims the benefit of provisional patent application Ser. No. 62/231,098, filed 2015 Jun. 24 by the present inventor.

### FEDERALLY SPONSORED RESEARCH

Not Applicable

### Sequence Listing or Program

Not Applicable

### BACKGROUND

### Field

This invention relates to synthetic boards used in vehicles, specifically boards used in the cargo beds of pickup trucks.

### Prior Art

New pickup trucks now feature a cargo bed that gives a one piece streamlined affect. Early model pickup trucks have used wooden boards for the floors of the cargo beds. People restoring early model pickups have gone to great lengths to capture the original classic wooden floor boards for their restoration projects.

When restoration of a vintage truck is complete, new wooden boards are placed in the bed of the truck with care to maintain a show room result. Wooden floor boards, while giving a classic appearance of the original truck bed, are prone to fading, moisture absorption, decay, and warp. Additionally, wooden boards are less resistant to abrasion than the new steel beds that replaced them. The ideal board would give the appearance of wood with abrasion and weather resistance.

U.S. Pat. No. 6,431,629 to Emery (2002) utilizes layers of thermoplastic and colorant to provide impact resistance, appearance, and slip resistance but is not suited to replace a vintage truck bed system. To gain acceptance in the truck conversion market, boards must have an antique appearance that is only provided by individual boards. A 3D effect may be printed on a one piece floor system to simulate individual boards, however this is not covered nor taught within this prior art.

U.S. Pat. No. 8,136,860 to Wise (2012) and U.S. Pat. No. 7,618,075 to Boddie (2009) offer novel means of protecting a modern truck bed. These inventions use finish and impact absorbing layers but are not suited to the conversion market for the reasons mentioned above.

U.S. Pat. No. 5,083,830 to Mucher (1992) teaches of a one-piece method of inserting a decorative and protective layer to a truck bed. Although this apparatus could be manufactured with printed images, advertising, and even wood grain patterns, no provisions have been made to adapt this concept to fastening to the many variances of support features found in vintage truck beds.

### SUMMARY OF THE INVENTION

According to one embodiment, the improved truck bed floor system (1) is furnished in a kit to be assembled and installed by the person restoring a vintage truck bed (2). Each board (3) consists of a structural base (4), an image layer (5), and an abrasion resistant layer (6). The image layer can be printed vinyl, produced using emersion graphics, or printed directly using the board as a substrate as opposed to traditional paper. This image layer (5) may contain a wood grain, advertising signage, or any custom image. The abrasion resistant layer (6) is preferably clear vinyl or PVC of the type commonly used as protection in floor graphics for retail stores but may also be a liquid applied to the image layer. Formed retaining clips (7) are installed against the protrusions (8) of the board to capture the protecting layer and clamp the board in place. Fasteners (9) are inserted through holes in the clips and into the bed frame of the truck (10).

One embodiment of the floor board consists of an aluminum extrusion that has a two outer legs (12) and may also contain a center rib (13) for added strength for wide boards. The outer legs (12) may also contain a foot member to keep the board in place during the first application of the retaining clip (7). A pocket (14) in the side protrusion (8) receives one of the legs of the retaining clip (7). Several boards (3) may be used with outer boards (16) trimmed to fit to reach the left and right side panel of the bed (2). Additionally, the outer board (16) can be manufactured narrower than the main boards (3) and may contain one or both outer legs (12) and may also contain a center rib (13).

Prior art in the truck industry relies on wooden boards (17) with a machined or formed side protrusion or tongue to accept the retaining clip (7).

### DRAWINGS

FIG. 1 is an isometric view of a truck bed with the floor system in place in accordance with one embodiment.

FIG. 2 is an enlarged view of FIG. 1 showing the left rear side of the truck bed and floor system in accordance with one embodiment.

FIG. 3 is an isometric view of the improved floor system in accordance with one embodiment.

FIG. 4 is a partially exploded view of the floor system with two of the retaining clips and corresponding hardware removed in accordance with one embodiment.

FIG. 5 is an end view of an extruded board in accordance with one embodiment.

FIG. 6 is a sectional view of an extruded board with retaining clips and hardware in place in accordance with one embodiment.

FIG. 7 is an enlarged sectional view of the retaining clip, fastener, and partial view of the side protrusions of the board in accordance with one embodiment.

FIG. 8 is an exploded view of the board with structural base, image layer, and protecting layer in accordance with one embodiment.

FIG. 9 is a view of prior art showing wooden boards with similar retaining clips and hardware.

FIG. 10 is a sectional view of prior art showing wooden boards assembled with retaining clips and hardware.

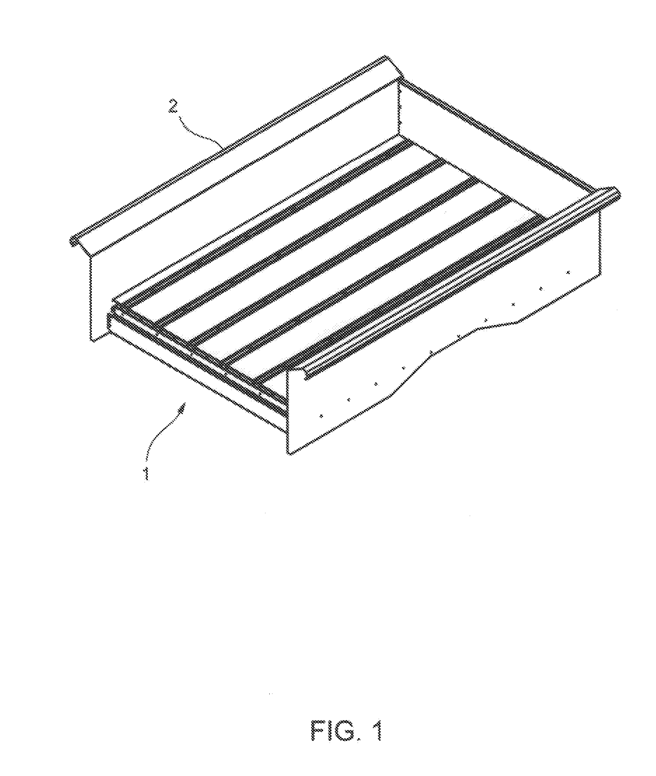

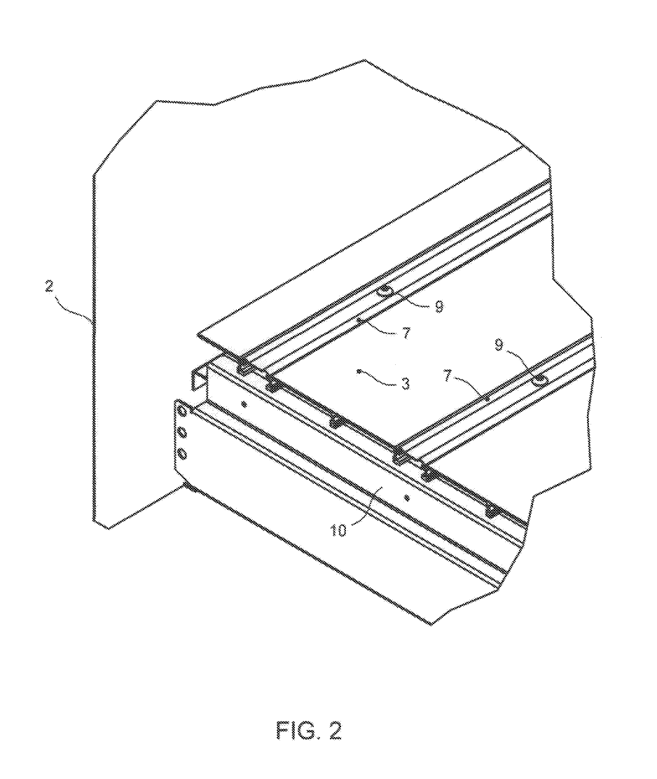

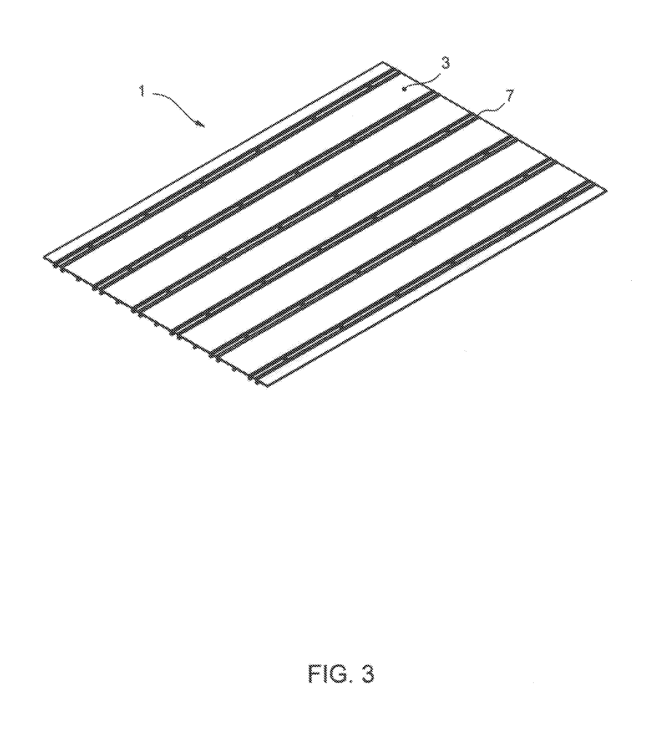

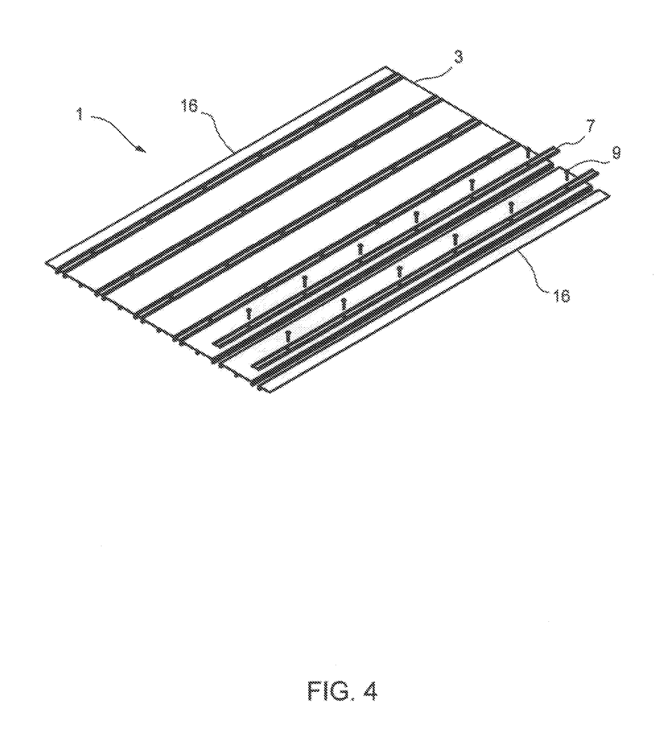

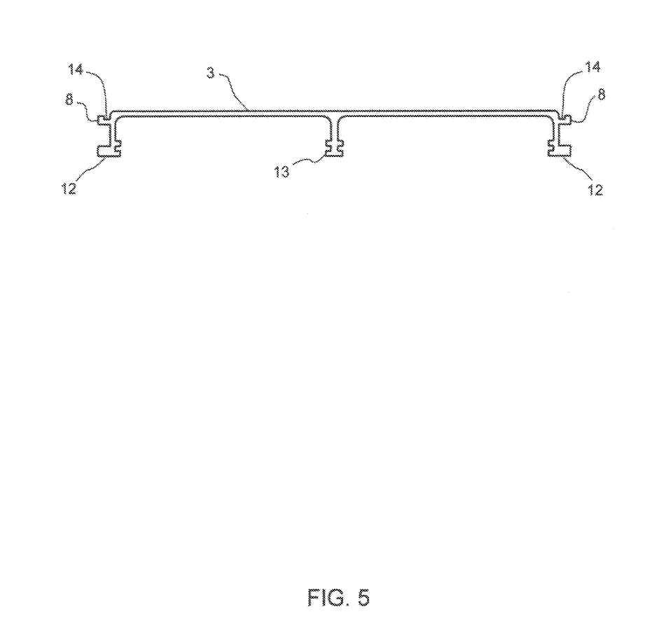

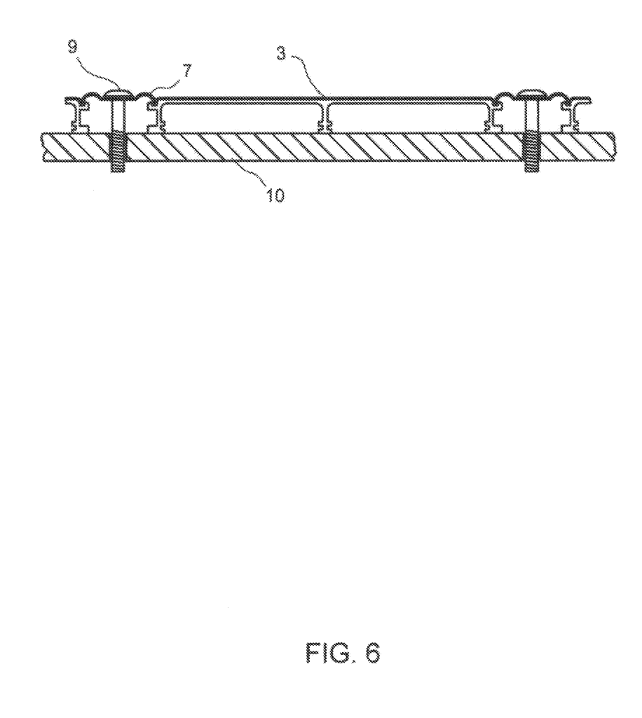

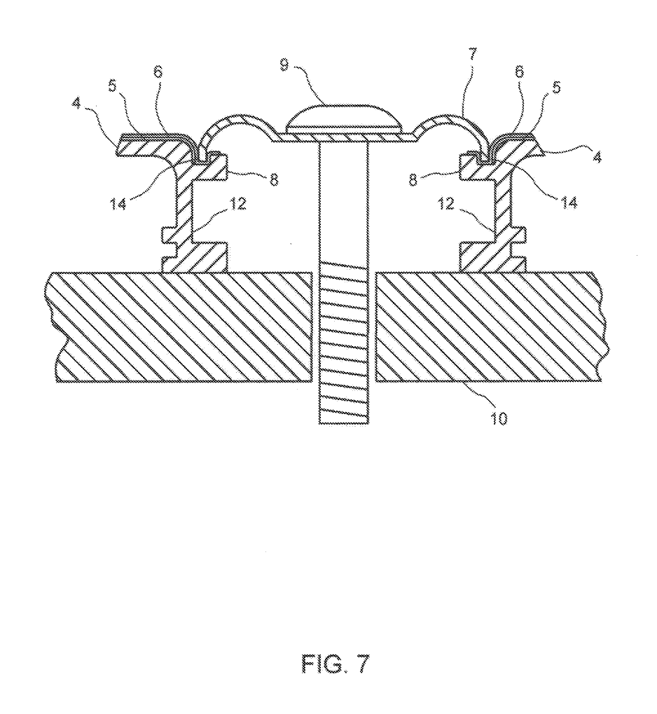

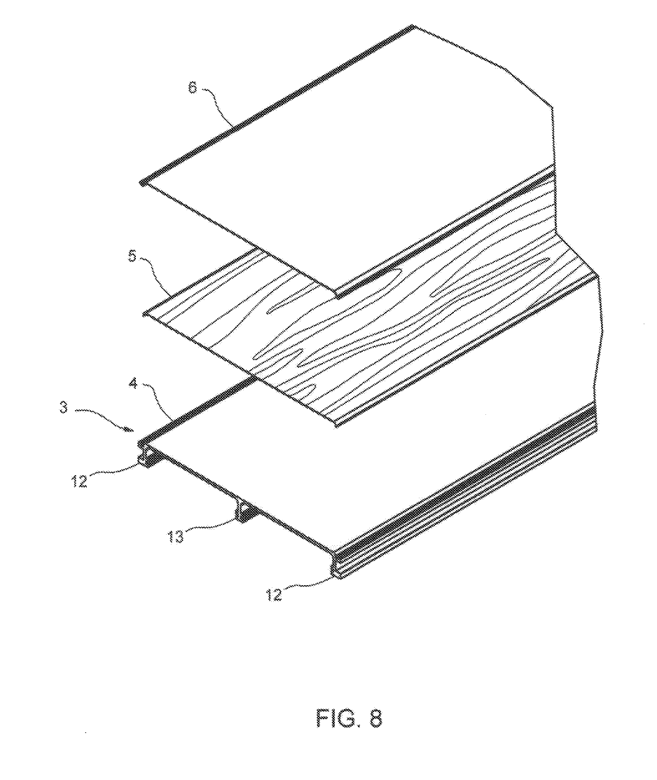

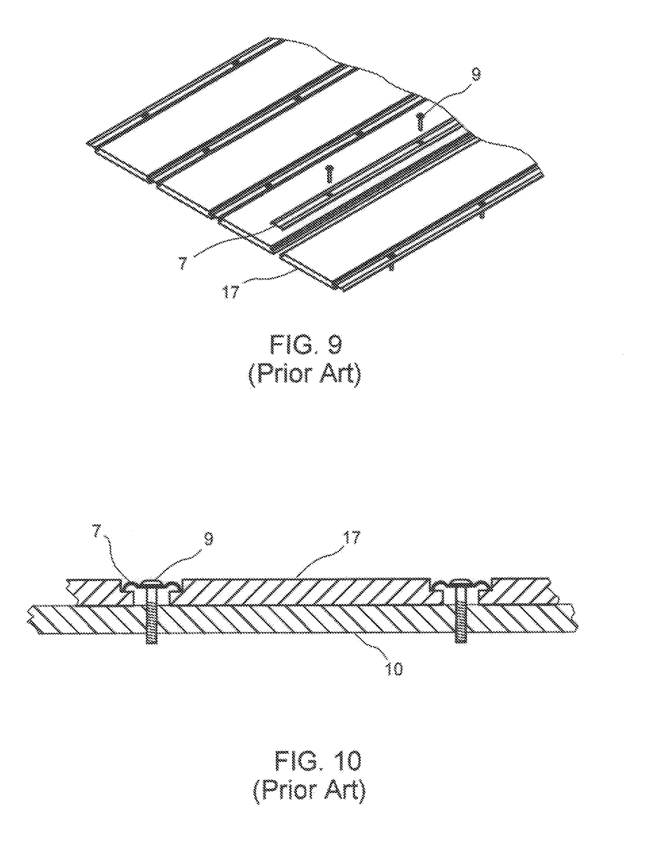

### REFERENCE NUMERALS

1 Floor system
2 Truck bed
3 Board
4 Structural layer
5 Image layer
6 Abrasion resistant layer
7 Retaining clips
8 Side protrusions
9 Fastener
10 Bed frame
12 Outer legs
13 Center rib
14 Board pocket
16 Outer board
17 Wooden board (prior art)

1. A vehicle cargo bed floor assembly comprising:
a. a plurality of non-wooden planks, each said plank having a top surface, two outer legs perpendicular to said top surface, and two ledges protruding from each of said outer legs,
b. a retaining clip having outer legs to clamp against the top surface of said ledges, and one or a plurality of mounting holes between said clip outer legs,
c. a plurality of fasteners found in the category containing threaded cap screws extending through said retaining clip mounting holes,
whereby said fasteners secure a plurality of said retaining clips to hold said planks stationary to one another and secure said planks to the frame of a vehicle cargo bed.

2. The non-wooden plank top surface of claim 1 further comprising:
a. a printed image layer and,
b. a protecting layer,
whereby said protecting layer covers the visible side of said printed image layer.

3. The protruding ledges of claim 1 further comprising:
a. a pocket for receiving said retaining clip outer legs to prevent unintentional lateral movement when secured with said fasteners.

4. The non-wooden plank of claim 1 further comprising:
a. a center rib parallel to said plank outer legs to support a load between said plank outer legs.

5. A non-wooden plank of a vehicle cargo bed comprising:
a. an image layer further comprising a digitized image of a natural wood grain pattern applied to the visible surface of said non-wooden plank and,
b. a protecting layer,
whereby said protecting layer covers the visible side of said printed image layer.
